(19) United States
(12) Patent Application Publication
(10) Pub. No.: US 2024/0385848 A1
(43) Pub. Date: Nov. 21, 2024

(54) PIPELINE ARCHITECTURE FOR CONFIGURING PROGRAMMABLE LOGIC DEVICE SYSTEMS AND METHODS

(71) Applicant: Lattice Semiconductor Corporation, Hillsboro, OR (US)

(72) Inventors: Tim Vogt, San Jose, CA (US); Kory Gong, San Jose, CA (US); Chunhua Zan, Shanghai (CN); Henry Tso, San Jose, CA (US)

(21) Appl. No.: 18/666,692

(22) Filed: May 16, 2024

Related U.S. Application Data
(60) Provisional application No. 63/502,888, filed on May 17, 2023.

(51) Int. Cl. G06F 9/4401

(52) U.S. Cl. CPC G06F 9/4403

(57) ABSTRACT

Various techniques are provided for configuring clients of a programmable logic device (PLD). In one embodiment, a method includes passing, from a configuration engine of a PLD, a plurality of transactions to clients of the PLD over a pipeline of the PLD. The method also includes executing each of the transactions by one or more of the clients. A first one of the transactions is a read transaction that causes at least a first one of the clients to retrieve read data and pass the read data over the pipeline. The method also includes passing the read data over the pipeline to the configuration engine. Additional systems and methods are also provided.

### CROSS-REFERENCE TO RELATED APPLICATIONS

This application claims priority to and the benefit of U.S. Provisional Patent Application No. 63/502,888 filed May 17, 2023 and entitled “PIPELINE ARCHITECTURE FOR CONFIGURING PROGRAMMABLE LOGIC DEVICE SYSTEMS AND METHODS,” which is hereby incorporated by reference in its entirety.

### TECHNICAL FIELD

This disclosure relates generally to programmable logic devices and, more specifically, to configuration techniques for programmable logic devices.

### BACKGROUND

Programmable logic devices (PLDs), such as field programmable gate arrays (FPGAs), complex programmable logic devices (CPLDs), field programmable systems on a chip (FPSCs), or other types of programmable devices may be configured with various user designs to implement desired functionality. The user designs may be synthesized and mapped to configurable resources and interconnections available in the PLDs.

The process of configuring of a PLD often requires communication between a configuration engine and the configurable resources. In devices having a small number of configurable resources, such communication may be performed using globally routed signals that connect from the configuration engine to each of the configurable resources of the PLD through associated configuration data routing paths.

However, for PLDs with large numbers (e.g., hundreds to millions) of configurable resources, such global routing techniques can result in substantial signal propagation delay that limits performance. In addition, the large number of separate and dedicated configuration data routing paths can increase complexity and consume significant silicon area in the PLD.

### SUMMARY

Various techniques are provided for configuring clients of a PLD. In one embodiment, a method includes: passing, from a configuration engine of a PLD, a plurality of transactions to clients of the PLD over a pipeline of the PLD; executing each of the transactions by one or more of the clients; wherein a first one of the transactions is a read transaction that causes at least a first one of the clients to retrieve read data and pass the read data over the pipeline; and passing the read data from the pipeline to the configuration engine.

In another embodiment, a PLD includes: a configuration engine; a plurality of clients; a pipeline to pass a plurality of transactions from the configuration engine to the clients for execution of each of the transactions by one or more of the clients; wherein a first one of the transactions is a read transaction that causes at least a first one of the clients to retrieve read data and pass the read data over the pipeline; and wherein the pipeline also passes the read data to the configuration engine.

### BRIEF DESCRIPTION OF THE DRAWINGS

FIG. 1 illustrates a block diagram of a PLD in accordance with an embodiment of the disclosure.

FIG. 2 illustrates a block diagram of a pipeline architecture of a PLD in accordance with an embodiment of the disclosure.

FIG. 3 illustrates a block diagram of a configuration engine of a PLD in accordance with an embodiment of the disclosure.

FIG. 4 illustrates a block diagram of a client of a PLD in accordance with an embodiment of the disclosure.

FIG. 5 illustrates another block diagram of a client of a PLD in accordance with an embodiment of the disclosure.

FIG. 6 illustrates another block diagram of a pipeline architecture of a PLD in accordance with an embodiment of the disclosure.

FIG. 7 illustrates a timing diagram of several signals passed to clients of a PLD in accordance with an embodiment of the disclosure.

FIG. 8 illustrates a process of configuring clients of a PLD in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with embodiments disclosed herein, various techniques are provided to configure programmable resources (also referred to as clients) of a PLD by a configuration engine. Such clients may include any configurable resources of the PLD such as programmable logic cells, embedded block random access memory (RAM), input/output (I/O) blocks, digital signal processor blocks, memories, registers, look-up tables (LUTs), gates, and/or other components.

In some embodiments, a pipeline architecture is provided to connect the configuration engine to a plurality of clients in a store-and-forward arrangement. For example, the configuration engine may generate and provide a plurality of transactions to the clients that, when executed by one or more of the clients, configure the clients in accordance with a design configuration of the PLD (e.g., as determined by configuration data stored locally to the PLD or remotely on an external device) and/or adjust operational states of the clients.

In some embodiments, in accordance with the store-and-forward arrangement, all clients of the PLD may receive all transactions. Each client may compare a client identifier (e.g., identifying one or more of the clients to which the transaction is directed) associated with the transaction to determine if the transaction is directed to the client. If the client identifier is associated with the client, the client executes the transaction and passes the transaction, any associated data (e.g., write data), and any results of the transaction (e.g., read data provided by the currently executing client) to the next client in the pipeline. Otherwise, the client does not execute the transaction but still passes the transaction, any associated data (e.g., write data), and any results of the transaction (e.g., read data provided by an upstream client) to the next client in the pipeline. As a result, all clients may receive and selectively execute any and all transactions as appropriate to configure the PLD.

Transactions may be processed by individual clients, multiple clients, and/or all clients as appropriate. For example, a transaction may be executed in a client-specific manner if its client identifier is associated with a single one of the clients to cause the single one of the clients of the PLD to execute the transaction.

A transaction may be executed by multiple clients if its client identifier is associated with a plurality of the clients comprising a subset of all of the clients of the PLD to cause each of the clients of the subset to execute the transaction. This can effectively provide a multicast operation in which a single transaction is used to configure multiple clients (e.g., a limited bulk configuration operation for a plurality of clients and/or all clients of a particular types such as embedded block RAM or other resources).

A transaction may be executed by all clients of the PLD if its identifier is associated with all of the clients of the PLD to cause all of the clients of the PLD to execute the transaction. This can effectively provide a broadcast operation in which a single transaction is used to configure all clients of the PLD.

Various types of transactions may be provided such as read transactions that cause a client to read (e.g., retrieve) data from a memory (e.g., memory blocks or registers) local to the client and return the read data to the configuration engine. Write transactions cause a client to write (e.g., store) data included in the transaction to a memory or register local to the client. Control transactions cause a client to adjust its operational state (e.g., to change the logic state of input and/or output ports of the client).

The pipeline architecture may be implemented with pipeline configured to pass information (e.g., using time division multiplexed signaling) for the transaction including client identifiers, read data, write data, memory addresses of the clients associated with the read data and the write data, control information associated with the transactions, and/or other information as appropriate. The pipeline may further pass read data from the clients back to the configuration engine.

In some embodiments, the pipeline may be implemented by a bus including a first set of parallel signal paths (e.g., a first portion) and a second set of parallel signal paths (e.g., a second portion) to pass various information to the clients simultaneously. In some embodiments, the bus may include a third set of parallel signal paths (e.g., a return branch also referred to as a third portion) to pass read data from the clients back to the configuration engine.

In the case of a read transaction, the pipeline (e.g., the first portion of the bus) may sequentially pass a client identifier and read data provided from a memory of a client after executing the read transaction. Also for the read transaction, the pipeline (e.g., the second portion of the bus) may pass a memory address of a memory of the client from which to retrieve the read data. Also for the read transaction, the first portion of the bus may pass read data from the clients to the return branch which passes the read data to the configuration engine as discussed.

In the case of a write transaction, the pipeline (e.g., the first portion of the bus) may sequentially pass a client identifier and write data to be stored in a memory of client after executing the write transaction. Also for the write transaction, the pipeline (e.g., the second portion of the bus) may pass a memory address of the memory of the client to which to store the write data.

In the case of a control transaction, the pipeline (e.g. the first portion of the bus) may sequentially pass a client identifier. Also for the control transaction, the pipeline (e.g., the second portion of the bus) may pass control information that, when processed by a client, causes the client to change its operational state. For example, the client may be caused to reset itself, reset its memory and/or registers, change the state of one or more output signals, and/or other changes in its operational state. In some embodiments, control transactions may be used to perform various operations that could otherwise be performed by the client in response to dedicated control signals (e.g., received at additional ports of the client separate from the first portion and the second portion of the pipeline). As a result, control transactions may be used instead of dedicated control signals to configure clients efficiently from the configuration engine itself without requiring dedicated control signals to be generated (e.g., by other components of the PLD in some embodiments). Such control transactions can be particularly useful to adjust the operational state of many clients when multicast or broadcast operations are performed using control transactions.

In some embodiments, control transactions adjust the operational state of clients of a PLD such as I/O blocks by setting their input and/or output ports to predetermined logic states before additional clients of the PLD are configured. In this regard, the PLD may appear to external devices with predetermined external facing logic states at its ports (e.g., effectively releasing the input and/or output ports of the PLD) while the remainder of the PLD continues to be configured. This can significantly improve boot times for systems in which a PLD is implemented. For example, such operations may be achieved by the configuration engine providing the control transactions for the I/O blocks early and/or at the beginning of the sequential flow of transactions provided to the pipeline architecture to cause the I/O block clients to execute their associated transactions before other transactions of various other clients of the PLD.

In some embodiments, the pipeline may be implemented with multiple branches to efficiently distribute transactions to all clients of the PLD. For example, the pipeline may include a main branch (e.g., including a first portion and a second portion) and a plurality of parallel sub-branches extending from the main branch (e.g., each of the sub-branches also including a first portion and a second portion). Each of the sub-branches may be connected to an associated subset of the clients (e.g., in rows, columns, and/or other arrangements).

In such an arrangement, the configuration engine may pass transactions to the main branch which sequentially passes them to the sub-branches. In various embodiments, appropriate registers may be provided throughout the main branch, the sub-branches, and the return bus to store and forward the transactions and data to clients throughout the pipeline architecture and pass read data to the configuration engine.

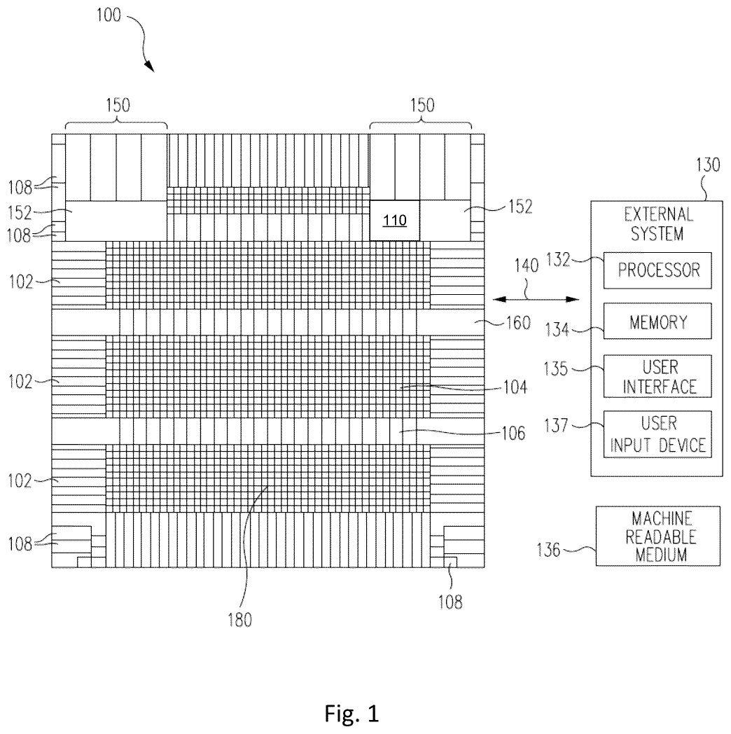

Referring now to the drawings, FIG. 1 illustrates a block diagram of a PLD 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes various clients such as input/output (I/O) blocks 102, logic blocks 104 (e.g., also referred to as programmable logic blocks (PLBs), programmable functional units (PFUs), or programmable logic cells (PLCs)) and others as discussed.

I/O blocks 102 provide I/O functionality (e.g., to support one or more I/O and/or memory interface standards) for PLD 100, while logic blocks 104 provide logic functionality (e.g., look-up table (LUT) logic or logic gate array-based logic) for PLD 100. Additional I/O functionality may be provided by serializer/deserializer (SERDES) blocks 150 and physical coding sublayer (PCS) blocks 152, any of which may be clients. In various embodiments, I/O blocks 102 and SERDES blocks 150 may route signals to and from associated external ports (e.g., physical pins) of PLD 100. PLD 100 may also include other clients such as hard intellectual property core (IP) blocks 160 to provide additional functionality (e.g., substantially predetermined functionality provided in hardware which may be configured with less programming than logic blocks 104).

PLD 100 may also include other clients such as memory blocks 106 (e.g., blocks of EEPROM memory blocks, RAM (e.g., static and/or dynamic) memory blocks, and/or flash memory blocks), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In various embodiments, routing resources 180 may include user configurable routing resources and hardwired signal paths. In general, the various components of PLD 100 may be used to perform their intended functions for desired applications, as would be understood by one skilled in the art.

For example, I/O blocks 102 may be used for programming PLD 100, such as memory blocks 106 (e.g., including volatile configuration memory) or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration data and commands (e.g., over one or more connections 140) to configure PLD 100 for its intended use and to support serial or parallel device configuration and information transfer with SERDES blocks 150, PCS blocks 152, hard IP blocks 160, and/or logic blocks 104 as appropriate.

For example, in some embodiments any of the various clients discussed herein may be configured in response to transactions provided by a configuration engine 110 (e.g., implemented by appropriate logic such as one or more processors, finite state machines, and/or other hardware and/or software) over a pipeline architecture (e.g., implemented by routing resources 180) as discussed herein. For example, configuration engine 110 may generate transactions using configuration data associated with a design configuration of PLD 100. In some embodiments, configuration data may be stored locally on PLD 100, for example, in one or more memory blocks 106 and/or stored externally from PLD 100, for example in a memory 134 of an external system 130.

It should be understood that the number and placement of the various components are not limiting and may depend upon the desired application. For example, various components may not be required for a desired application or design specification (e.g., for the type of programmable device selected).

Furthermore, it should be understood that the components are illustrated in block form for clarity and that various components would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

System 130 (e.g., also referred to as an external device) may be used to create a desired user configuration or design of PLD 100 and generate corresponding configuration data. Such configuration data may be stored in PLD 100 as discussed and used by configuration engine 110 to generate transactions provided to a pipeline architecture to configure clients of PLD 100 as discussed herein. In some embodiments, configuration engine 110 may be implemented by processor 132 of external system to provide transactions to the pipeline architecture of PLD 100 through I/O blocks 102, SERDES blocks 150, and/or otherwise as appropriate.

In the illustrated embodiment, system 130 is implemented as a computer system. In this regard, system 130 includes, for example, one or more processors 132 (e.g., implemented by appropriate logic as discussed with regard to configuration engine 110) which may be configured to execute instructions, such as software instructions, provided in one or more memories 134 and/or stored in non-transitory form in one or more non-transitory machine-readable mediums 136 (e.g., a memory or other appropriate storage medium internal or external to system 130). For example, in some embodiments, system 130 may run a PLD configuration application, such as Lattice Diamond System Planner and/or Lattice Radiant software available from Lattice Semiconductor Corporation to permit a user to create a desired configuration and generate corresponding configuration data to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100 and/or to identify various triggers used to evaluate the operation of PLD 100, as further described herein.

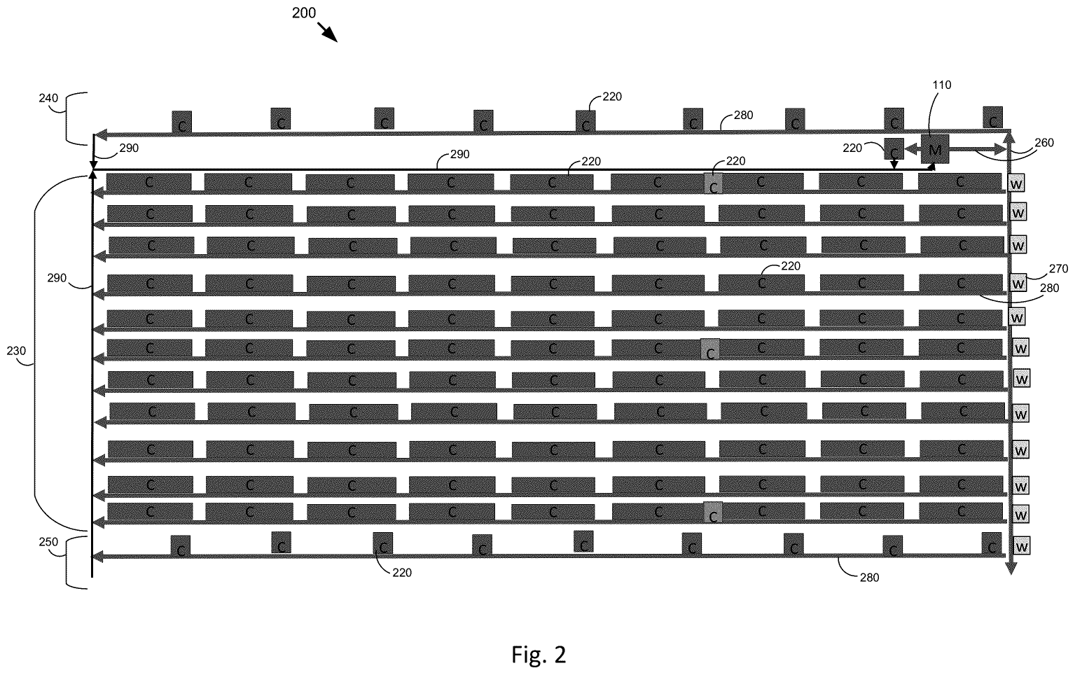

FIG. 2 illustrates a block diagram of a pipeline architecture comprising a pipeline 200 of PLD 100 in accordance with an embodiment of the disclosure. As discussed, pipeline 200 may be implemented by routing resources 180 of PLD 100.

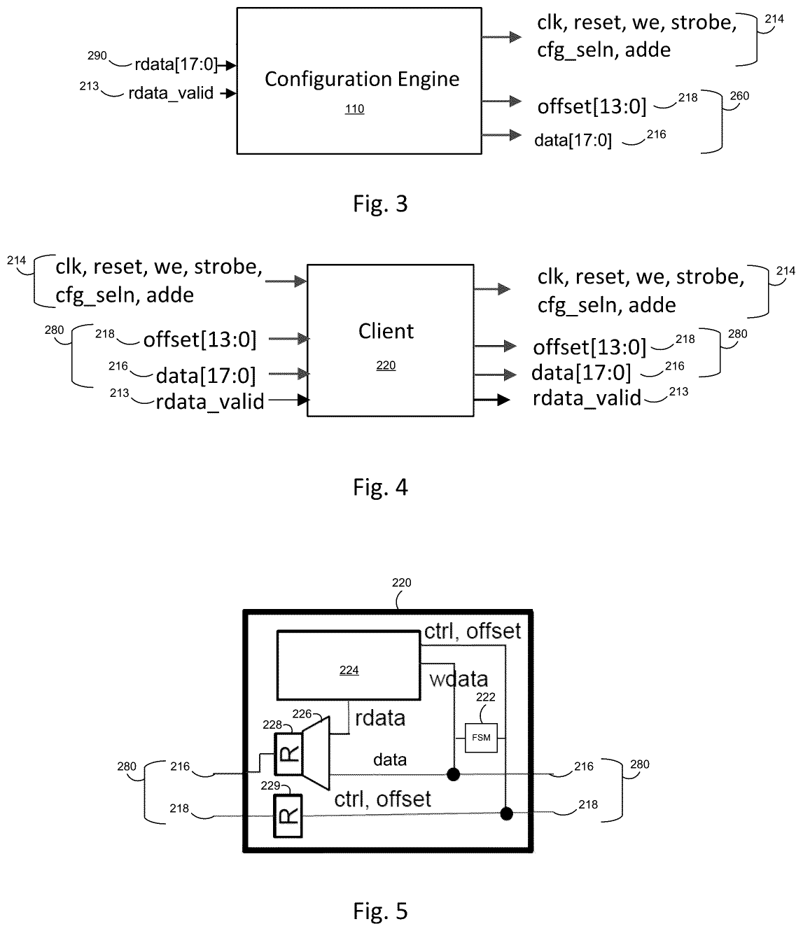

As shown, pipeline 200 includes a main branch 260, a plurality of sub-branches 280 connected to main branch 260 (e.g., in parallel with each other as shown), a plurality of registers 270, and a return branch 290. As discussed, main branch 260 includes a unidirectional bus comprising a first portion 216 and a second portion 218 (further illustrated in FIGS. 3 to 6), and sub-branches 280 also include the unidirectional bus comprising first portion 216 and second portion 218 as discussed herein.

Configuration engine 110 is connected to main branch 260 and return branch 290. A plurality of clients 220 are connected to sub-branches 280. In some embodiments, one or more additional clients 220 may be connected to configuration engine 110 as shown.

In operation, configuration engine 110 generates transactions using configuration data as discussed and provides the transactions sequentially in a serial manner to main branch 260. Transactions passed by main branch 260 are stored (e.g., latched) by registers 270 and passed down sub-branches 280 to clients 220 in a store-and-forward arrangement. As a result, every client 220 receives every transaction, selectively executes the transaction (e.g., depending on the client identifier associated with the transaction), and passes the transaction with any associated data (e.g., write data or read data) to the next client 220 in the sub-branch 280.

Sub-branches 280 are connected to a return branch 290 that passes read data retrieved by clients 220 in response to read transactions to configuration engine 110. In some embodiments, one or more clients 220 may be connected directly to return branch 290 as shown.

In some embodiments, clients 220 may be arranged in a plurality of rows and columns. For example, in FIG. 2, a plurality of rows 230 of clients 220 may be associated with primary internal configurable resources of PLD 100. In addition, rows 240 and 250 of clients 220 may be associated with peripheral configurable resources of PLD 100, such as I/O blocks 102 and/or others.

FIG. 3 illustrates a block diagram of configuration engine 110 of PLD 100 in accordance with an embodiment of the disclosure. Configuration engine 110 provides a plurality of control signals through a control bus 214 (e.g., implemented by routing resources 180 of PLD 100). In some embodiments, control transactions may be used to implement one or more operations of the control signals as discussed.

Configuration engine 110 is connected to main branch 260 that includes a unidirectional bus comprising first portion 216 and second portion 218. Configuration engine 110 provides transactions and related data over first portion 216 and second portion 218. For example, in the illustrated embodiment, main branch pipeline provides a 32 bit bus including 18 bit first portion 216 (data [17:0]) that passes client identifiers for transactions provided by configuration engine 110 and 14 bit second portion 218 (offset [13:0]) that passes memory addresses for transactions provided by configuration engine 110.

Configuration engine 110 receives read data retrieved by clients 220 in response to transactions from 18 bit return branch 290 (rdata [17:0]). Configuration engine 110 is also connected to a read data valid signal path 213 (rdata_valid) (e.g., provided by routing resources 180 of PLD 100).

FIG. 4 illustrates a block diagram of a client 220 of PLD 100 in accordance with an embodiment of the disclosure. Client 220 may be any of the various clients of PLD 100 discussed herein.

As shown, client 220 is connected to control bus 214 to receive and pass control signals provided by configuration engine 110. Client 220 is also connected to first portion 216 and second portion 218 of one of sub-branches 280 to receive and pass transactions and related data as discussed. Client 220 is also connected to read data valid signal path 213.

FIG. 5 illustrates another block diagram of client 220 of FIG. 4 in further detail in accordance with an embodiment of the disclosure. Client 220 receives transactions over first portion 216 and second portion 218. Specifically, over first portion 216, client 220 receives client identifiers for all transactions, write data for write transactions, and read data provided by other upstream clients 220 in response to their execution of read transactions. Over second portion 218, client 220 receives memory addresses for write transactions, memory addresses for read transactions, and instructions for control transactions.

As shown, first portion 216 and second portion 218 are connected to a finite state machine (FSM) 222, a memory 224 (e.g., a memory or register), a multiplexer 226, and output registers 228 and 229 of client 220. FSM 222 processes the transactions received over first portion 216 and second portion 218 to determine the response of client 220 thereto. For example, FSM 222 compares the client identifier received over first portion 216 to a known client identifier of client 220. If the client identifiers match, client 220 executes the transaction (e.g., in a single client, multicast, or broadcast manner as discussed).

In the case of a write transaction, the client identifier received over first portion 216 is followed by one or more data packets to be stored in memory 224 (e.g., memory blocks or registers) under the control of FSM 222. The address of memory 224 to which the write data is to be stored is received over second portion 218. The client identifier and the write data pass through multiplexer 226 and output register 228 to the next client 220 over first portion 216. Similarly, the address passes through output register 229 to the next client 220 over second portion 218. As a result, the write transaction is passed to the next client 220 for possible execution, regardless of whether FSM 222 executes the write transaction. If FSM 222 executes the write transaction, then the write data (e.g., identified as wdata in this case) is stored in the corresponding address of memory 224.

In the case of a read transaction, the client identifier received over first portion 216 is followed by one or more data packets (if any) that have been previously retrieved from a memory 224 of an upstream client 220. The address of memory 224 from which the read data is to be retrieved is received over second portion 218. If FSM 222 does not execute the read transaction, then the client identifier and the upstream read data (if any) pass through multiplexer 226 and output register 228 to the next client 220 over first portion 216. Similarly, the address passes through output register 229 to the next client 220 over second portion 218. As a result, the read transaction and any previously read data (if any) is passed to the next client 220 for possible execution, even if FSM 222 does not execute the read transaction. If FSM 222 executes the read transaction, then data is retrieved from the identified address of memory 224 and passed through multiplexer 226 (e.g., identified as rdata in this case) and output register 228 (e.g., rather than read data passed by upstream clients 220 in the case where the read transaction is not executed by the current client 220).

In the case of a control transaction, the client identifier is received over first portion 216 and additional control information is received over second portion 218. If FSM 222 executes the control transaction, then FSM 222 adjusts the operational state of client 220 appropriately. Regardless of whether the control transaction is executed by client 220, the client identifier passes through multiplexer 226 and output register 228 to the next client 220 over first portion 216, and the control information passes through output register 229 to the next client 220 for possible execution over second portion 218.

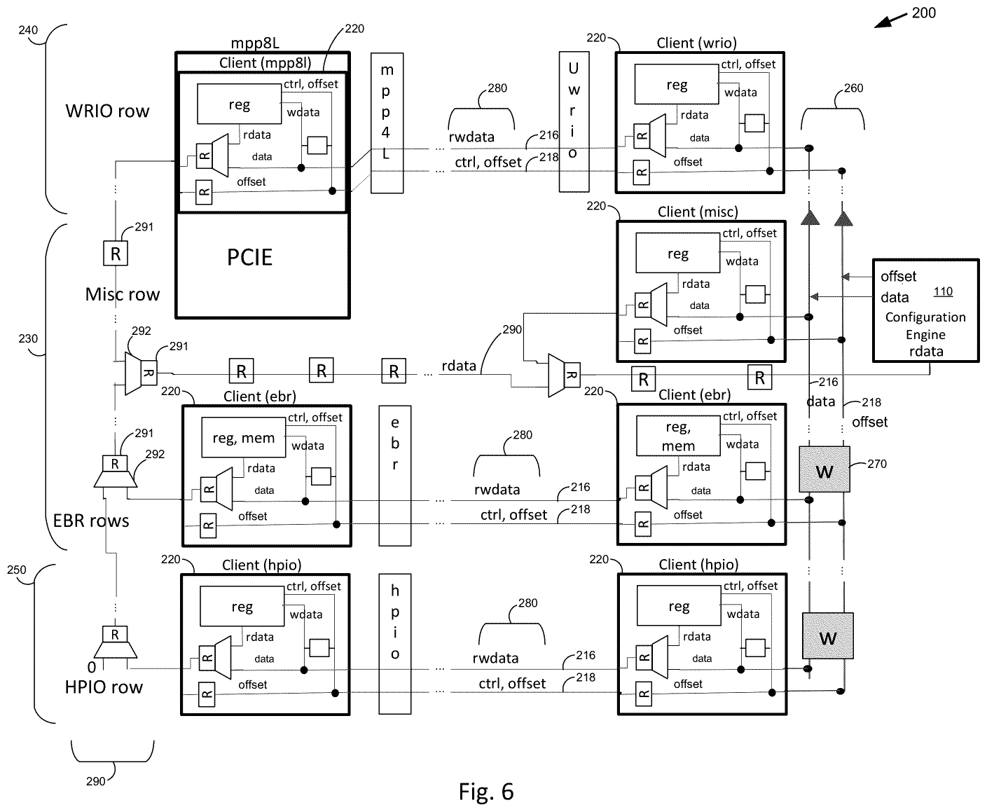

FIG. 6 illustrates another block diagram of pipeline 200 of FIG. 2 in further detail in accordance with an embodiment of the disclosure. For example, in FIG. 6, first portion 216 and second portion 218 of main branch 260 and sub-branches 280 are shown separately. Clients 220 are shown with further details previously discussed with regard to FIG. 5. Return branch 290 is also shown with further details including registers 291 and multiplexers 292.

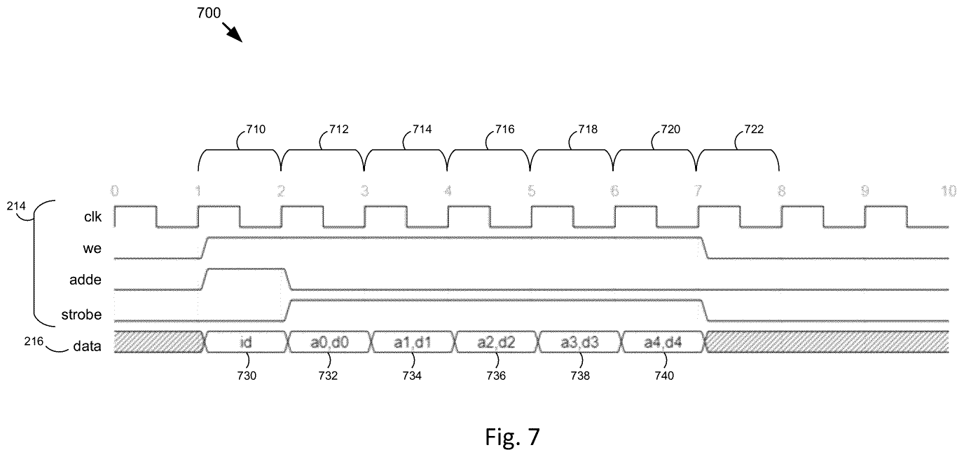

The sequential operation of transactions can be further appreciated with reference to FIG. 7. In this regard, FIG. 7 illustrates a timing diagram 700 of several signals passed to clients 220 of PLD 100 in accordance with an embodiment of the disclosure.

In FIG. 7, various signals of control bus 214 and first portion 216 are shown for an example write transaction that extends over six clock cycles 710 to 720. At clock cycle 710, a write enable signal (we) and an address signal (adde) transition to a logic high state. In addition, a client identifier 730 is received over first portion 216.

At clock cycle 712, the address signal (adde) transitions to a logic low state and a strobe signal transitions to a logic high state. In addition, a first packet 732 of write data is received over first portion 216. In the case of a read transaction, a first packet of read data may be received instead (e.g., read data passed by an upstream client 220 that previously executed the read transaction).

At clock cycles 714, 716, 718, and 720, additional write data packets 734, 736, 738, and 740 (or read data packets in the case of a read transaction) are received over first portion 216. At clock cycle 722, the write enable (we) signal and the strobe signal transition to a logic low state and the transaction is completed.

Although six clock cycles are illustrated for the example write transaction of FIG. 7, any number of clock cycles may be used (e.g., greater or fewer than those illustrated in FIG. 7 depending on the number of write data or read data packets associated with the transaction).

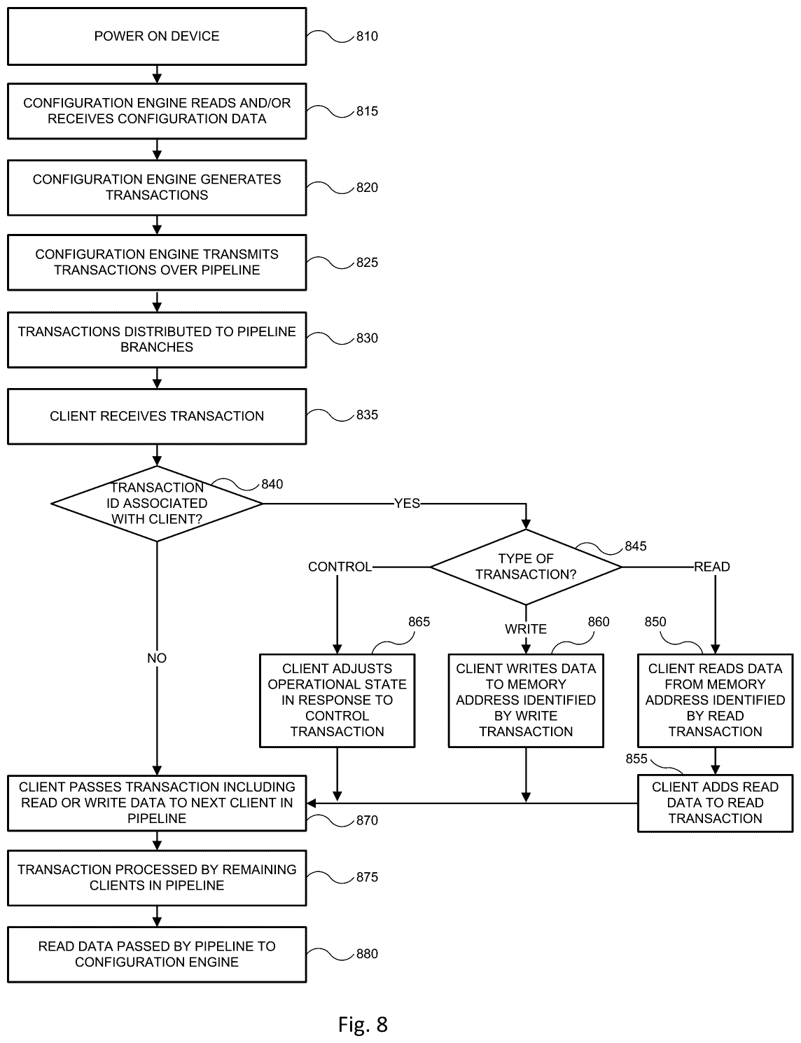

FIG. 8 illustrates a process of configuring clients 220 of PLD 100 in accordance with an embodiment of the disclosure. In operation 810, PLD 100 is powered on, for example, in response to a power on reset operation or other appropriate manner.

In operation 815, configuration engine 110 receives configuration data, for example, by reading it from configuration memory (e.g., one or more memory blocks 106 and/or memory 134) and/or receiving it from an external source (e.g., such as external system 130 or otherwise) over one or more I/O blocks (e.g., JTAG, SPI, SSPI, and/or other inputs). In operation 820, configuration engine 110 generates transactions using the configuration data. In operation 825, configuration engine 110 transmits (e.g., passes) the transactions through pipeline 200, for example, to main branch 260 and/or any directly connected clients 220. In operation 830, main branch 260 distributes (e.g., passes) the transactions to sub-branches 280.

As discussed, configuration engine 110 may provide large numbers of transactions (e.g., thousands or millions) sequentially in a serial manner. Accordingly, configuration engine 110 may continue to generate and pass transactions to clients through pipeline 200 while the remaining operations of FIG. 8 are performed.

Operations 840 to 870 describe the manner in which one of clients 220 receives, selectively executes, and passes the transactions provided by configuration engine 110. In operation 835, one of clients 220 receives one of the transactions. In operation 840, the FSM 222 of client 220 compares the client identifier received over first portion 216 to a known client identifier of client 220 and selectively executes the transaction. In this regard, if the client identifiers match, the process continues to operation 845 where client 220 begins executing the transaction (e.g., in a single client, multicast, or broadcast manner as discussed). If the client identifiers do not match, then the process continues to operation 870.

In operation 845, FSM 222 determines whether the transaction is a read transaction, a write transaction, or a control transaction. In the case of a read transaction, the process continues to operation 850 where FSM 222 retrieves read data from memory 224 using the read address provided by the transaction. Thereafter in operation 855, FSM 222 adds the read data to the read transaction by passing the read data to first portion 216 as discussed.

In the case of a write transaction, the process continues to operation 860 where FSM 222 stores the write data included in the transaction to the write address of memory 224 provided by the transaction.

In the case of a control transaction, the process continues to operation 865 where FSM 222 adjusts the operational state of client 220 appropriately.

In operation 870, client 220 passes the transaction (e.g., including any associated write data or read data) to the next client 220 in pipeline 200. In operation 875, the transaction is processed by the remaining clients 220 connected to pipeline 200 where the transaction may be executed by one or more of the remaining clients 220 (e.g., in a single client, multicast, or broadcast manner as discussed).

In operation 880, any read data provided by one or more clients 220 in response to executed read instructions is passed by return branch 290 of pipeline 200 to configuration engine 110. Following the processing and selective execution of all transactions by all of clients 220, PLD 100 will be configured for operation in accordance with the design configuration specified by the configuration data.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
passing, from a configuration engine of a programmable logic device (PLD), a plurality of transactions to clients of the PLD over a pipeline of the PLD;
executing each of the transactions by one or more of the clients;
wherein a first one of the transactions is a read transaction that causes at least a first one of the clients to retrieve read data and pass the read data over the pipeline; and
passing the read data over the pipeline to the configuration engine.

2. The method of claim 1, wherein a second one of the transactions is a write transaction that causes at least a second one of the clients to store write data included in the write transaction and pass the write data over the pipeline.

3. The method of claim 1, wherein a third one of the transactions is a control transaction that causes at least a third one of the clients to adjust its operational state.

4. The method of claim 1, wherein:
each transaction comprises a client identifier; and
the executing comprises executing the transaction by all of the clients associated with the client identifier.

5. The method of claim 4, wherein each of the transactions is one of:
a client-specific transaction wherein its client identifier is associated with a single one of the clients to cause the single one of the clients to execute the client-specific transaction;
a multicast transaction wherein its client identifier is associated with a plurality of the clients comprising a subset of the clients of the PLD to cause each of the clients of the subset to execute the multicast transaction; or
a broadcast transaction wherein its client identifier is associated with all of the clients of the PLD to cause all of the clients of the PLD to execute the broadcast transaction.

6. The method of claim 1, wherein:
at least a subset of the clients are input/output (I/O) blocks of the PLD;
the transactions associated with the I/O blocks are passed prior to the transactions associated with a remaining subset of the clients; and
the executing comprises executing the transactions associated with the I/O blocks prior to executing the transactions associated with the remaining subset of clients to maintain the I/O blocks at predetermined states while the remaining subset of clients are configured by the transactions.

7. The method of claim 1, further comprising:
receiving, by the configuration engine, configuration data associated with a design configuration of the PLD;
generating, by the configuration engine, the transactions in response to the configuration data; and
wherein the executing configures the PLD according to the design configuration.

8. The method of claim 1, wherein the pipeline comprises a unidirectional bus using time division multiplexed signaling, the bus comprising:
a first portion to pass client identifiers, read data, and write data associated with the transactions; and
a second portion to pass memory addresses of the clients associated with the read data and the write data and also to pass control information associated with the transactions.

9. The method of claim 1, wherein:
the pipeline comprises a main branch, a plurality of sub-branches extending from the main branch, and a return branch connected between the sub-branches and the configuration engine;
each of the sub-branches is connected to an associated subset of the clients;
the passing from the configuration engine comprises passing the transactions to the main branch;
the method further comprises passing the transactions from the main branch to each of the sub-branches; and
the passing the read data comprises passing the read data over the return branch.

10. The method of claim 1, wherein:
the clients are programmable components of the PLD comprising one or more of:
embedded random access memory (RAM) blocks,
registers, and
input/output (I/O) blocks; and
all of the clients receive all of the transactions over the pipeline.

11. A programmable logic device (PLD) comprising:
a configuration engine;
a plurality of clients;
a pipeline to pass a plurality of transactions from the configuration engine to the clients for execution of each of the transactions by one or more of the clients;
wherein a first one of the transactions is a read transaction that causes at least a first one of the clients to retrieve read data and pass the read data over the pipeline; and
wherein the pipeline also passes the read data to the configuration engine.

12. The PLD of claim 11, wherein a second one of the transactions is a write transaction that causes at least a second one of the clients to store write data included in the write transaction and pass the write data over the pipeline.

13. The PLD of claim 11, wherein a third one of the transactions is a control transaction that causes at least a third one of the clients to adjust its operational state.

14. The PLD of claim 11, wherein:
each transaction comprises a client identifier; and
the transaction is executed by all of the clients associated with the client identifier.

15. The PLD of claim 14, wherein each of the transactions is one of:
a client-specific transaction wherein its client identifier is associated with a single one of the clients to cause the single one of the clients to execute the client-specific transaction;
a multicast transaction wherein its client identifier is associated with a plurality of the clients comprising a subset of the clients of the PLD to cause each of the clients of the subset to execute the multicast transaction; or
a broadcast transaction wherein its client identifier is associated with all of the clients of the PLD to cause all of the clients of the PLD to execute the broadcast transaction.

16. The PLD of claim 11, wherein:
at least a subset of the clients are input/output (I/O) blocks of the PLD;
the pipeline passes the transactions associated with the I/O blocks prior to the transactions associated with a remaining subset of the clients; and
the transactions associated with the I/O blocks are executed prior to the transactions associated with the remaining subset of clients to maintain the I/O blocks at predetermined states while the remaining subset of clients are configured by the transactions.

17. The PLD of claim 11, wherein:
the configuration engine receives configuration data associated with a design configuration of the PLD;
the configuration engine generates the transactions in response to the configuration data; and
wherein the execution of the transactions configures the PLD according to the design configuration.

18. The PLD of claim 11, wherein the pipeline comprises a unidirectional bus using time division multiplexed signaling, the bus comprising:
a first portion to pass client identifiers, read data, and write data associated with the transactions; and
a second portion to pass memory addresses of the client associated with the read data and the write data and also to pass control information associated with the transactions.

19. The PLD of claim 11, wherein:
the pipeline comprises a main branch, a plurality of sub-branches extending from the main branch, and a return branch connected between the sub-branches and the configuration engine;
each of the sub-branches is connected to an associated subset of the clients;
the configuration engine passes the transactions to the main branch;
the main branch passes the transactions to each of the sub-branches; and
the return branch passes the read data to the configuration engine.

20. The PLD of claim 11, wherein:
the clients are programmable components of the PLD comprising one or more of:
embedded random access memory (RAM) blocks,
registers, and
input/output (I/O) blocks; and
all of the clients receive all of the transactions over the pipeline.
